(19) United States
(12) Patent Application Publication
(10) Pub. No.: US 2026/0326780 A1
(43) Pub. Date: Oct. 22, 2026

(54) ADAPTIVE NOTIFICATION MANAGEMENT SYSTEM FOR A VEHICLE

(71) Applicant: GM Global Technology Operations LLC, Detroit, MI (US)

(72) Inventors: Vivek Vijaya Kumar, Shelby Township, MI (US); Manoj Kumar Sharma, Troy, MI (US); Akilesh Rajavenkatanarayanan, Macomb, MI (US); Shah Hussain, Dearborn, MI (US)

(73) Assignee: GM Global Technology Operations LLC, Detroit, MI (US)

(21) Appl. No.: 19/180,797

(22) Filed: Apr. 16, 2025

(51) Int. Cl. B60W 50/14; B60W 30/18; B60W 50/00; G06N 3/02

(52) U.S. Cl. CPC B60W 50/14; B60W 30/18154; G06N 3/02; B60W 2050/0083; B60W 2520/10; B60W 2554/4029; B60W 2554/406; B60W 2555/60; B60W 2556/20; B60W 2556/40; B60W 2556/65

(57) ABSTRACT

A computer-implemented method when executed by data processing hardware causes the data processing hardware to perform operations. The operations include receiving, at an adaptive notification management architecture, intersection data based on a location of a vehicle equipped with the adaptive notification management architecture, receiving, at the adaptive notification management architecture, vehicle data of the vehicle, the vehicle data including at least one of the location of the vehicle and vehicle speed, and arbitrating, via the adaptive notification management architecture, the intersection data and the vehicle data. The operations also include generating a confidence score and a severity score based on the arbitrated intersection data and the arbitrated vehicle data and generating, based on the confidence score and the arbitrated intersection data and the arbitrated vehicle data, one or more notifications with respect to an intersection.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an adaptive notification management system for a vehicle.

Vehicles travel on roads and often encounter traffic signals that regulate the flow of traffic and enhance safety. Traffic signals typically include a set of lights that display different colors, such as red, yellow, and green, to indicate when vehicles should stop, prepare to stop, or proceed through an intersection. Some traffic signals may also include additional features, such as arrows, flashing lights, or signs, to indicate specific conditions or directions for vehicles or pedestrians.

While some vehicles are equipped with systems that can indicate upcoming intersections and give warnings when the vehicle is approaching an object at speed, such systems may not be able to anticipate signal systems, such as timing of lights, and provide contextual information to the operator of how the vehicle may perform based on the contextual information. For example, such systems may not be able to communicate with the traffic signal or receive information from the traffic signal, or may not be able to process or present the information in a useful or intuitive way to the operator. Therefore, there is a need for an improved system that can anticipate signal systems, such as timing of lights, and provide contextual information to the operator of how the vehicle may perform based on the contextual information.

### SUMMARY

In some aspects, a computer-implemented method when executed by data processing hardware causes the data processing hardware to perform operations. The operations include receiving, at an adaptive notification management architecture, intersection data based on a location of a vehicle equipped with the adaptive notification management architecture, receiving, at the adaptive notification management architecture, vehicle data of the vehicle, the vehicle data including at least one of the location of the vehicle and vehicle speed, and arbitrating, via the adaptive notification management architecture, the intersection data and the vehicle data. The operations also include generating a confidence score and a severity score based on the arbitrated intersection data and the arbitrated vehicle data and generating, based on the confidence score and the arbitrated intersection data and the arbitrated vehicle data, one or more notifications with respect to an intersection.

In some examples, the intersection data may include signal, phase, and time (SPaT) data and map data. Optionally, the map data may include a geometry of the intersection. In some instances, the intersection data may include traffic data and pedestrian data. In some examples, receiving the intersection data may include receiving the intersection data from a signal at the intersection. In other examples, receiving the intersection data may include receiving the intersection data from a secondary vehicle proximate to the intersection. The operations may also include sorting, via the adaptive notification management architecture, vehicle applications based on the severity score and the confidence score. The operations may further include generating, based on the severity score, a weight for each vehicle application. Optionally, generating the weight for each vehicle application may include executing a deep learning algorithm and assigning, via the deep learning algorithm, a priority for one of the vehicle applications. In other examples, generating the confidence score and the severity score includes calculating a distance to intersection (DTI) and a time to intersection (TTI) of the vehicle.

In further aspects, an adaptive notification management system for a vehicle includes data processing hardware and memory hardware in communication with the data processing hardware. The memory hardware stores instructions that when executed on the data processing hardware cause the data processing hardware to perform operations. The operations include receiving, at an adaptive notification management architecture, intersection data based on a location of a vehicle equipped with the adaptive notification management architecture, the intersection data including one or more of signal, phase, and time (SPaT) data, map data, traffic data, and pedestrian data, receiving, at the adaptive notification management architecture, vehicle data of the vehicle, the vehicle data including at least one of the location of the vehicle and vehicle speed, and arbitrating, via the adaptive notification management architecture, the intersection data and the vehicle data. The operations also include generating a confidence score and a severity score based on the arbitrated intersection data and the arbitrated vehicle data, sorting, via the adaptive notification management architecture, vehicle applications based on the severity score and the confidence score, and generating, based on the confidence score and the arbitrated intersection data and the arbitrated vehicle data, one or more notifications with respect to an intersection.

In some examples, the map data may include a geometry of the intersection. Optionally, receiving the intersection data includes receiving the intersection data from a signal at the intersection. In some instances, receiving the intersection data includes receiving the intersection data from a secondary vehicle proximate to the intersection. The operations may also include generating, based on the severity score, a weight for each vehicle application. In further examples, generating the weight for each vehicle application may include executing a deep learning algorithm and assigning, via the deep learning algorithm, a priority for one of the vehicle applications. Optionally, generating the confidence score and the severity score may include calculating a distance to intersection (DTI) and a time to intersection (TTI) of the vehicle.

In other aspects, an adaptive notification management system for a vehicle includes data processing hardware and memory hardware in communication with the data processing hardware. The memory hardware stores instructions that when executed on the data processing hardware cause the data processing hardware to perform operations. The operations include receiving, at an adaptive notification management architecture, intersection data from at least one of a signal at an intersection and a secondary vehicle proximate to the intersection based on a location of a vehicle equipped with the adaptive notification management architecture, the intersection data including one or more of signal, phase, and time (SPaT) data, map data, traffic data, and pedestrian data, receiving, at the adaptive notification management architecture, vehicle data of the vehicle, the vehicle data including at least one of the location of the vehicle and vehicle speed, and arbitrating, via the adaptive notification management architecture, the intersection data and the vehicle data. The operations also include generating a confidence score and a severity score based on the arbitrated intersection data and the arbitrated vehicle data, sorting, via the adaptive notification management architecture, vehicle applications based on the severity score and the confidence score, generating, based on the severity score, a weight for each vehicle application, and generating, based on the confidence score and the arbitrated intersection data and the arbitrated vehicle data, one or more notifications with respect to an intersection.

In some examples, generating the weight for each vehicle application may include executing a deep learning algorithm and assigning, via the deep learning algorithm, a priority for one of the vehicle applications. Optionally, generating the confidence score and the severity score may include calculating a distance to intersection (DTI) and a time to intersection (TTI) of the vehicle.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle equipped with an adaptive notification management system according to the present disclosure;

FIG. 2 is an exemplary block diagram of an adaptive notification management system according to the present disclosure;

FIG. 3 is a schematic of a vehicle equipped with an adaptive notification management system according to the present disclosure, the vehicle approaching an intersection and in communication with an intersection system and a secondary vehicle;

FIG. 4 is another schematic of a vehicle equipped with an adaptive notification management system according to the present disclosure, the vehicle approaching an intersection and in communication with an intersection system;

FIG. 5 is an example flow diagram of an adaptive navigation management system according to the present disclosure;

FIG. 6 is another example flow diagram of an adaptive navigation management system according to the present disclosure;

FIG. 7 is yet another example flow diagram of an adaptive navigation management system according to the present disclosure; and

FIG. 8 is an example a method of operation of an adaptive navigation management system according to the present disclosure;

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

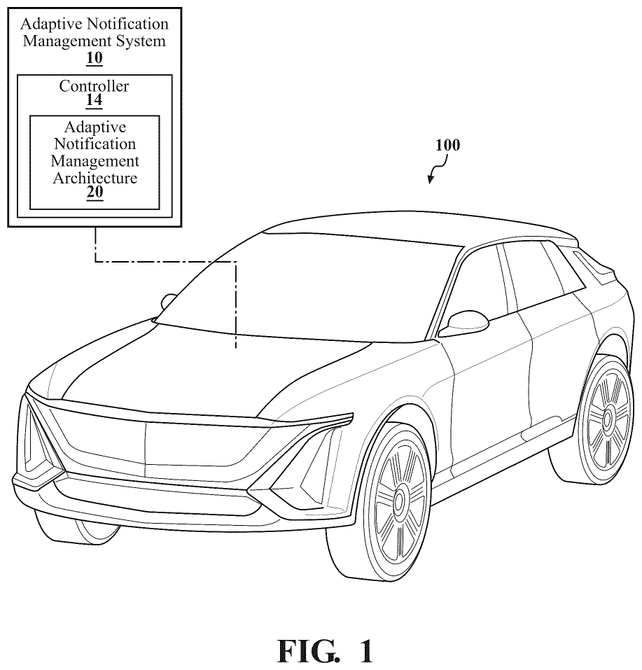

Referring to FIGS. 1-4, a vehicle 100 is configured with an adaptive notification management system 10 that is communicatively coupled with an intersection system 200. While described herein with respect to an intersection system 200, it is appreciated that the adaptive notification management system 10 is not limited to communication with intersection systems 200 and may be utilized in combination with other systems that may result in notifications to the vehicle 100. For example, the adaptive notification management system 10 may be communicatively coupled with the intersection system 200 via a network 300 including, but not limited to, cellular and/or cloud-based network systems. For example, the adaptive notification management system 10 may receive intersection data 202 from a signal 204 of the intersection system 200. The adaptive notification management system 10 may also be communicatively coupled with secondary vehicles 400 that may also be equipped with an adaptive notification management system 10. The adaptive notification management system 10 is configured to gather the intersection data 202 from one or both of the intersection system 200 and/or the secondary vehicles 400 via the network 300. For example, the adaptive notification management system 10 is configured to assist an operator when the vehicle 100 is approaching an intersection 206 by gathering the intersection data 202.

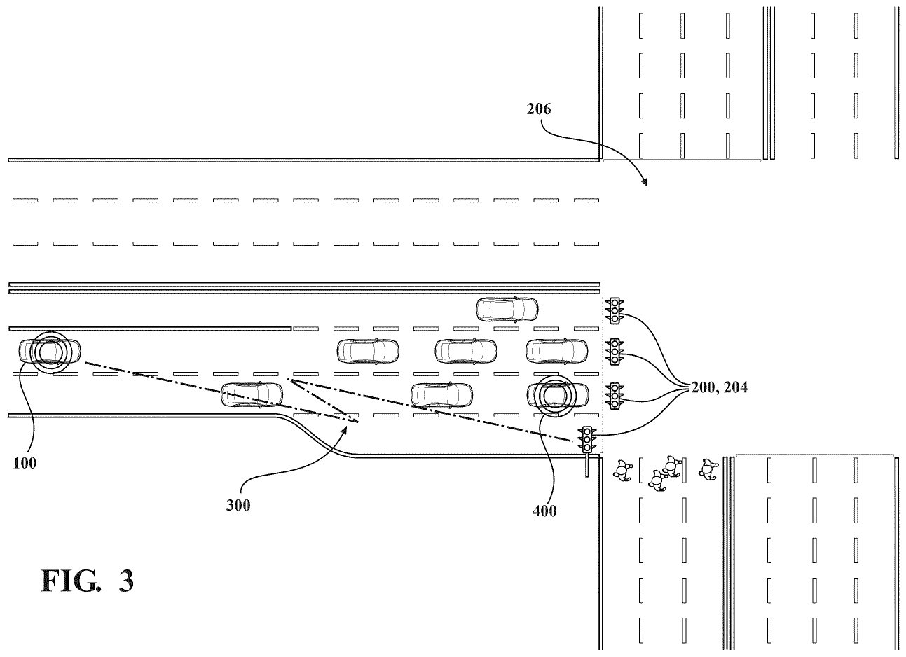

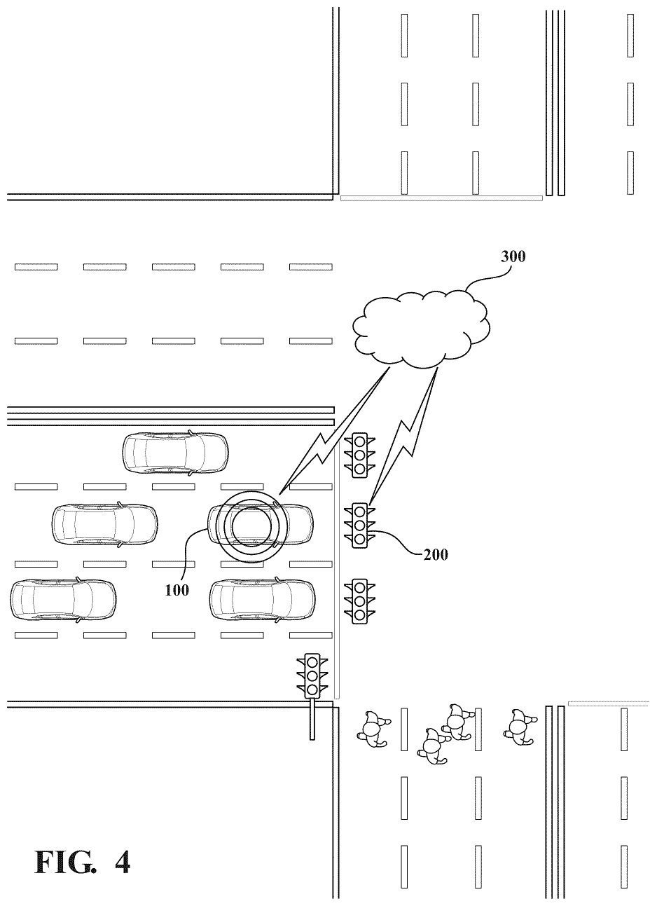

FIGS. 3 and 4 illustrate exemplary intersections 206 equipped with the intersection system 200. FIG. 3 illustrates one example of the intersection system 200 being communicatively coupled with the vehicle 100 via a cellular network 300. The vehicle 100 is also illustrated as being communicatively coupled with a secondary vehicle 400 that is also equipped with an adaptive notification management system 10 that is in communication with the intersection system 200. The vehicle 100 may receive the intersection data 202 from either the intersection system 200 or the secondary vehicle 400. In some instances, the vehicle 100 may receive the intersection data 202 from both the intersection system 200 and the secondary vehicle 400. FIG. 4 illustrates one example of the intersection system 200 being communicatively coupled with the vehicle 100 via a cloud-based network 300 to receive the intersection data. Although not depicted in FIG. 4, the vehicle 100 may be equally communicatively coupled with a secondary vehicle 400 via the cloud-based network 300 to gather the intersection data 202.

The intersection data 202 may include, but is not limited to, signal, phase, and time (SPaT) data 208, map data 210, traffic data 212, and pedestrian data 214. For example, the map data 210 may include a geometry 210a of the intersection 206. The adaptive notification management system 10 is configured to receive the intersection data 202 based on a location 102 of the vehicle 100. For example, the adaptive notification management system 10 captures vehicle data 104 including, but not limited to, the location 102 of the vehicle 100 relative to the intersection 206 and/or vehicle speed 106. The location 102 of the vehicle 100 may inform the adaptive notification management system 10 which, if any, intersection systems 200 the vehicle 100 is proximate, approaching, or otherwise near. The adaptive notification management system 10 utilizes both the intersection data 202 and the vehicle data 104 to generate one or more notifications 12 with respect to the intersection 206, described in more detail below.

With further reference to FIGS. 1-4, the adaptive notification management system 10 includes a controller 14 of the vehicle 100. The controller 14 includes data processing hardware 16 and memory hardware 18 in communication with the data processing hardware 16. The memory hardware 18 stores instructions that, when executed by the data processing hardware 16, cause the data processing hardware 16 to perform operations. For example, the data processing hardware 16 is configured to execute an adaptive notification management architecture 20 in response to the intersection data 202 and the vehicle data 104. The data processing hardware 16 is also configured with a plurality of vehicle applications 22 that are arbitrated by the adaptive notification management architecture 20 in response to receiving the intersection data 202 and the vehicle data 104.

The vehicle applications 22 include, but are not limited to, a vehicle-to-signal application 22a, a queue estimation 22b, an automated operating application 22c, a pedestrian monitoring application 22d, and an enhanced engine operation application 22e. The vehicle-to-signal application 22a may be configured to issue the notifications 12 pertaining to a signal status 204a. While described herein with respect to a signal status 204a, the notifications 12 may also pertain to other driving scenarios, such as forward collision prevention. Further, the adaptive notification management architecture 20 is configured to manage the notifications 12 to prioritize at least one of the vehicle applications 22 and minimize an overload of information to the driver.

In one example, the notifications 12 issued by the vehicle-to-signal application 22a may include a red light violation warning and a green light optimal speed advisory. The adaptive notification management architecture 20 is also configured to determine a distance-to-intersection (DTI) 24 and a time-to-intersection (TTI) 26 of the vehicle 100 based on the vehicle data 104. As described herein, the adaptive notification management architecture 20 utilizes the DTI 24 and the TTI 26 to generate a confidence score 28 and a severity score 30, described in more detail below. The notifications 12 may be conveyed to a driver via a shrinking and/or expanding object on a user interface, heads-up display (HUD), cluster display, or any other practicable vehicle display unit. The shrinking and/or expanding of the notification 12 may be based on the distance-to-intersection (DTI) 24 and the time-to-intersection (TTI) 26.

The adaptive notification management architecture 20 is configured with an arbitration function 32. The arbitration function 32 is configured to arbitrate the intersection data 202 and the vehicle data 104. As a result of the arbitrated intersection data 202 and the arbitrated vehicle data 104, the adaptive notification management architecture 20 generates the confidence score 28 and the severity score 30. For example, the arbitration function 32 may be utilized by the adaptive notification management architecture 20 to generate the confidence score 28 and the severity score 30. The confidence score 28 is configured to assist the adaptive notification management architecture 20 in determining the reliability and validity of the intersection data 202, which is utilized to then identify which of the vehicle applications 22 may be triggered.

For example, the adaptive notification management architecture 20 may utilize the arbitration function to determine the confidence score 28 associated with the SPaT data 208. The resultant confidence score 28 may be utilized by the adaptive notification management architecture 20 to generate the severity score 30 for the vehicle-to-signal application 22a based on the confidence score 28 associated with the arbitrated SPaT data 208 and the arbitrated vehicle data 104. The adaptive notification management architecture 20 may also utilize the DTI 24 and the TTI 26, in combination with the confidence score 28, to determine the severity score 30 of the vehicle application 22. For example, the DTI 24 and the TTI 26 may be calculated as part of the process of generating the confidence score 28 and the severity score 30.

The adaptive notification management architecture 20 is configured to sort the vehicle applications 22 based on the confidence scores 28 and the severity scores 30. For example, each vehicle application 22 may be assigned a weight 34 that is generated based on the severity score 30. The adaptive notification management architecture 20 may be configured with a deep learning algorithm 40 and may execute the deep learning algorithm 40 to generate the weight 34. The deep learning algorithm 40 may assign a priority 42 to each of the vehicle applications 22 that generally corresponds to the weight 34. The deep learning algorithm 40 is configured to predict the vehicle application 22 that is most likely to have a high priority 42 of execution given the intersection data 202 and the vehicle data 104. In other configurations, the adaptive notification management architecture 20 functions without the deep learning algorithm 40 and relies on the weights 34 assigned to each vehicle application 22 to determine a respective priority 42.

The adaptive notification management architecture 20 is configured to predict the signal status 204a when the vehicle 100 is anticipated to be passing through the intersection 206. For example, the intersection data 202 may include the signal status 204a (i.e., green, yellow, red) and a signal duration 204b (i.e., time remaining at the signal status 204a). The adaptive notification management architecture 20 compares the DTI 24 and the TTI 26 with the signal status 204a and signal duration 204b to anticipate the end of the signal status 204a relative to the DTI 24 and TTI 26 of the vehicle 100. Specifically, the adaptive notification management architecture 20 utilizes the SPaT data 208 in combination with the DTI 24 and the TTI 26 to determine the weight 34 that should be assigned to the vehicle applications 22.

For example, the DTI 24 may include a far region 24a, a mid-region 24b, and a warning region 24c. The severity score 30 generally corresponds to the DTI 24 in that the respective region 24a-24c of the DTI 24 correlates with the severity score 30. The severity score 30 may include a low severity 30a, a medium severity 30b, and a high severity 30c. The low severity 30a corresponds to the far region 24a of the DTI 24. The medium severity 30b corresponds to the mid-region 24b of the DTI 24, and the high severity 30c corresponds to the stopping region 24c of the DTI 24. The adaptive notification management architecture 20 also utilizes the confidence score 28 with respect to the DTI 24 and the severity score 30. For example, the higher the severity score 30, 30a-c the higher the confidence score 28 required by the adaptive notification management architecture 20. Thus, the low severity 30a corresponds to a low required confidence 28a, and the high severity 30c corresponds to a high required confidence 28b.

The adaptive notification management architecture 20 adapts which notifications 12 to generate based on the severity score 30, the confidence score 28, and the DTI 24. For example, if the DTI 24 is in the far region 24a, the adaptive notification management architecture 20 may issue a notification 12 including a green light optimal speed advisory (GLOSA), traffic information, and/or recommend a lane change. If the DTI 24 is in the mid-region 24b, the adaptive notification management architecture 20 may issue the GLOSA based on medium severity 30b. If the DTI 24 is in the warning region 24c, then the adaptive notification management architecture 20 may issue the GLOSA, a red light violation warning (RLVW), an automatic stop, a pedestrian notification, and/or a one pedal drive suggestion. In some instances, the notification 12 may include the DTI 24 and may display the DTI 24 on a user interface of the vehicle 100.

The severity score 30 may differ depending on the notification 12. For example, an RLVW notification 12 has a high severity 30c as compared to a GLOSA notification 12. While both the RLVW notification 12 and the GLOSA notification 12 may be potential notifications 12 generated by the adaptive notification management architecture 20, the adaptive notification management architecture 20 utilizes the weights 34 to assign the priority 42 to each notification 12. As a result, the adaptive notification management architecture 20 selects to generate the notification(s) 12 with the highest priority 42 over those with lower priority 42. For example, the notifications 12 with the lower priority 42 may correspond to informative notifications 12 that may provide contextual information to an operator of the vehicle 100 as opposed to safety warnings that may be associated with the notifications 12 having the highest priority 42.

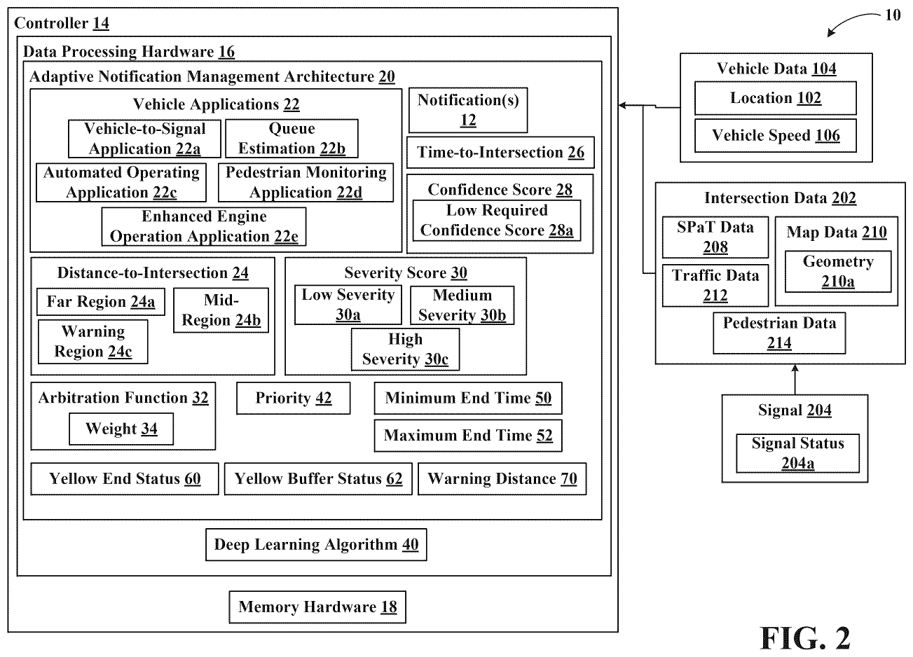

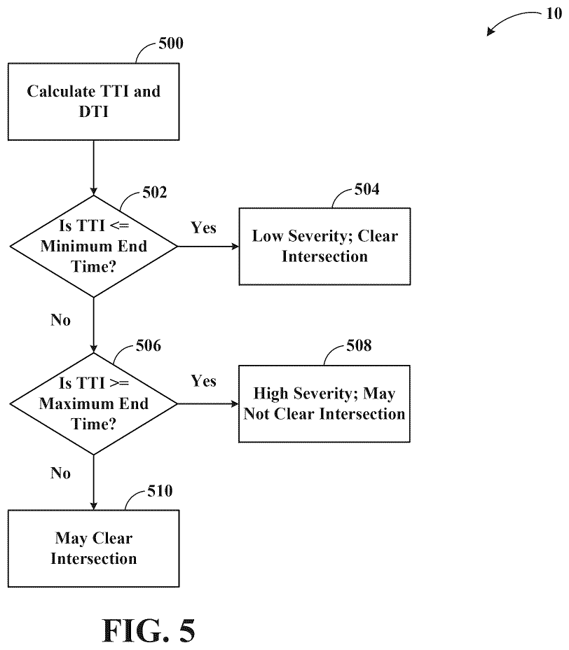

With reference to FIGS. 2-15, exemplary flow diagrams of the adaptive notification management system 10 are illustrated. For example, FIG. 5 depicts example where the signal status 204a is green and the vehicle 100 is approaching the intersection 206. The adaptive notification management architecture 20 calculates, at 500, the DTI 24 and the TTI 26 and determines, at 502, whether the TTI 26 is less than or equal to a minimum end time 50. The minimum end time 50 may be defined as a cut-off point at which the TTI 26 automatically changes the severity score 30 from a low severity 30a to one of the medium or high severities 30b, 30c. If the TTI 26 is less than or equal to the minimum end time 50, the adaptive notification management architecture 20 may issue, at 504, a notification 12 indicating the vehicle 100 will clear the intersection 206 within the green signal status 204a.

If the TTI 26 is greater than the minimum end time 50, then the adaptive notification management architecture 20 determines, at 506, whether the TTI 26 is greater than or equal to a maximum end time 52. The maximum end time 52 corresponds to the cut-off point at which the TTI 26 automatically changes the severity score 30 from one of the lower severity 30a or medium severity 30b to the high severity 30c. If the TTI 26 is greater than the maximum end time 50, then the adaptive notification management architecture 20 generates, at 508, a notification 12 indicating that the vehicle may not clear the intersection 206 during the current signal 204, such that the severity score 30 is high. For example, the notification 12 may correspond to the RLVW notification 12. If the TTI 26 is less than the maximum end time 52, then the adaptive notification management architecture 20 generates, at 510, a notification 12 indicating that the vehicle 100 may clear intersection 206 during the current signal 204.

When the TTI 26 is between the minimum end time 50 and the maximum end time 52, the severity score 30 is the medium severity 30b. The adaptive notification management architecture 20 may determine that the vehicle 100 could follow a GLOSA notification 12, such that the vehicle speed 106 may be sufficient to meet an optimal speed 106a to pass through the signal 204 even if the predicted duration of the signal status 204a is relatively inaccurate. As the vehicle 100 approaches the optimal speed 106a, the adaptive notification management architecture 20 provides more accurate recommendations via the GLOSA notification 12. Further, the TTI 26 being between the minimum end time 50 and the maximum end time 52 and the DTI 24 is within the warning region 24c may still result in the GLOSA notification 12 rather than the RLVW notification 12, as the vehicle 100 is determined to be likely to pass through the intersection 206 during the signal 204.

In general, the confidence score 28 may be lower when the DTI 24 is in the far or mid-regions 24a, 24b. As a result, the adaptive notification management architecture 20 may continually refresh the notifications 12 generated as the vehicle 100 approaches the intersection 206 to provide a more accurate assessment of the likelihood of the vehicle 100 passing through the intersection 206 during the signal 204. For example, as the vehicle 100 gets closer to the warning region 24c, the adaptive notification management architecture 20 generates a more accurate GLOSA notification 12. In some instances, the GLOSA notification 12 may include a recommendation to increase the vehicle speed 106 to reduce the arrival time at the intersection 206 and increase the likelihood of the vehicle 100 passing through the intersection 206 during the signal 204. While the GLOSA notification 12 may correspond to the vehicle 100 passing through the intersection 206, the GLOSA notification 12 may also include stopping the vehicle 100 prior to passing through the intersection 206 based on the likelihood that vehicle 100 will not pass through the intersection 206 during the signal 204.

In some instances, the vehicle 100 may be stopped at the intersection 206. The adaptive notification management architecture 20 may determine the location 102 of the vehicle 100 relative to the intersection 206 and may evaluate the traffic data 212 received as part of the intersection data 202. The adaptive notification management architecture 20 may utilize the location 102 of the vehicle 100 and the traffic data 212 to determine a position of the vehicle 100 within a queue. The adaptive notification management architecture 20 may utilize the position to execute the queue estimation 22b. Based on the queue estimation 22b, the adaptive notification management architecture 20 may also execute the automated operation application 22c. The intersection data 202 may also include the signal status 204a, such that the adaptive notification management architecture 20 may anticipate a change in the signal status 204a when activating the automated operation application 22c.

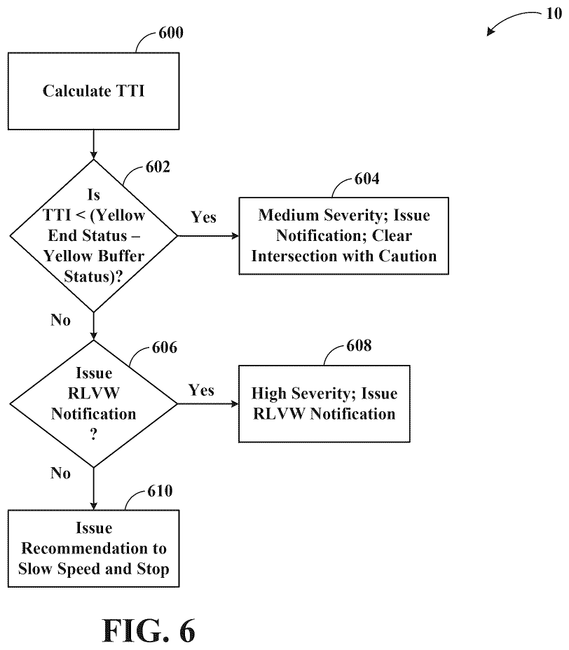

With reference to FIG. 6, the adaptive notification management system 10 is illustrated where the signal status 204a is yellow and the vehicle 100 is approaching the intersection 206. At 600, the adaptive notification management architecture 20 calculates the TTI 26 for the approaching intersection 206 and determines, at 602, whether the TTI 26 is less than the difference between a yellow end status 60 and a yellow buffer status 62. If the TTI 26 is less than the difference, then adaptive notification management architecture 20 generates, at 604, a notification 12 corresponding to the medium severity 30b. For example, if the location 102 of the vehicle 100 is close to the intersection 206 when the signal status 204a is yellow, the vehicle 100 may be able to clear the intersection 206.

If the TTI 26 is not less than the difference between the yellow end status 60 and the yellow buffer status 62, then the adaptive notification management architecture 20 determines, at 606, whether to issue the RLVW notification 12. If yes, then the adaptive notification management architecture 20 issues the RLVW notification 12, at 608, associated with the high severity 30c. If not, then adaptive notification management architecture 20 issues, at 610, a notification 12 recommending the vehicle 100 come to a stop with the high severity 30c. For example, the adaptive notification management architecture 20 determines that the vehicle 100 is not able to clear the intersection 206 during the signal 204. If the vehicle 100 is within the warning region 24c and is not slowing down, then the adaptive notification management architecture 20 issues the RLVW notification 12. If the vehicle 100 is within the far region 24a or mid-region 24b, then the adaptive notification management architecture 20 issues, at 610, the GLOSA notification 12 including an instruction to slow down and stop.

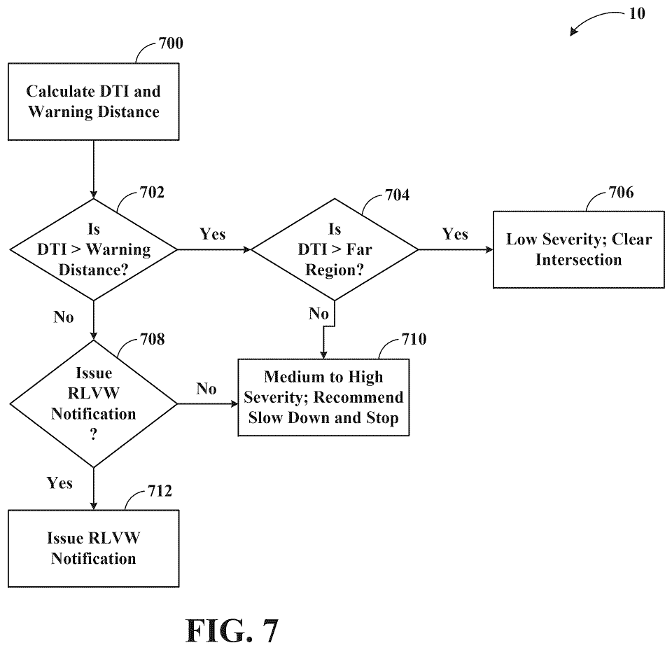

With reference to FIG. 7, the adaptive notification management system 10 is illustrated where the signal status 204a is red and the TTI 26 is variable. At 700, the adaptive notification management architecture 20 calculates the DTI 24 and a warning distance 70. The adaptive notification management architecture 20 determines, at 702, if the DTI 24 is greater than the warning distance 70. If the DTI 24 is greater than the warning distance 70, then the adaptive notification management architecture 20 determines, at 704, if the DTI 24 is greater than the far region 24a. If the DTI 24 is greater than the far region 24a, then the adaptive notification management architecture 20 determines, at 706, low severity 30a. For example, the vehicle 100 may be in the far region 24a or mid-region 24a, and the duration of the signal status 204a may be inaccurate (i.e., the SPaT data 208 may have a low confidence score 28). The closer the vehicle 100 gets to the intersection 206, the more accurate the duration of the signal status 204a will be.

If the DTI 24 is not greater than the warning distance 70, then the adaptive notification management architecture 20 determines, at 708, whether to issue the RLVW notification 12. If the adaptive notification management architecture 20 determines not to issue the RLVW notification 12, then the adaptive notification management architecture 20 issues, at 710, a GLOSA notification 12 including a recommendation to slow speed and stop, and the adaptive notification management architecture 20 determines a medium to high severity 30b, 30c. The adaptive notification management architecture 20 will similarly issue the GLOSA notification 12 if the DTI 24 is not greater than the far region 24a. If the adaptive notification management architecture 20 determines to issue, at 712, the RLVW notification 12, then the adaptive notification management architecture 20 determines the high severity 30c.

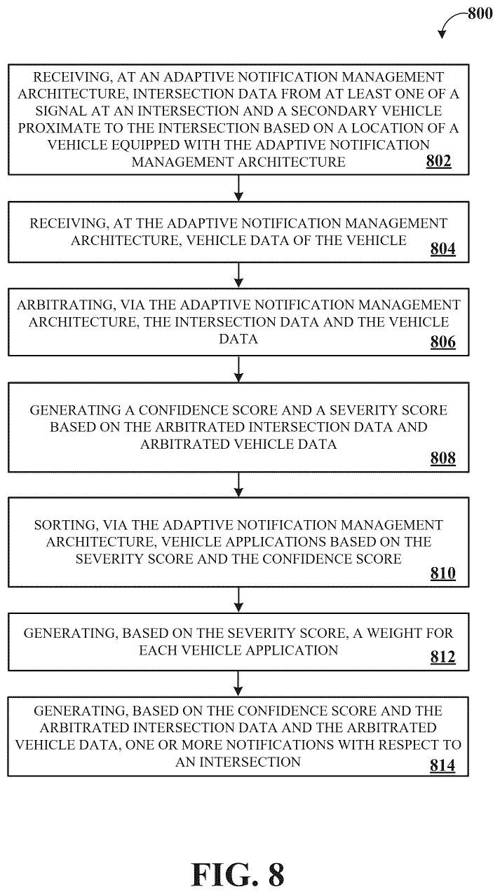

With reference to FIG. 8, a method 800 of operation of the adaptive notification management system 10 is illustrated. At 802, an adaptive notification management architecture 20 receives intersection data 202 from at least one of a signal 204 at an intersection 206 and a secondary vehicle 400 proximate to the intersection 206 based on a location 102 of a vehicle 100 equipped with the adaptive notification management architecture 20. The intersection data 202 includes one or more of signal, phase, and time (SPaT) data 208, map data 210, traffic data 212, and pedestrian data 214. The adaptive notification management architecture 20 receives, at 804, vehicle data 104 of the vehicle 100. The vehicle data 104 includes at least one of the location 102 of the vehicle 100 and vehicle speed 106. At 806, the adaptive notification management architecture 20 arbitrates the intersection data 202 and the vehicle data 104. A confidence score 28 and a severity score 30 are generated, at 808, based on the arbitrated intersection data 202 and the arbitrated vehicle data 104. At 810, the adaptive notification management architecture 20 sorts vehicle applications 22 based on the severity score 30 and the confidence score 28. At 812, a weight 34 is generated for each vehicle application 22 based on the severity score 30. Based on the confidence score 28 and the arbitrated intersection data 202 and the arbitrated vehicle data 104, one or more notifications 12 are generated, at 814, with respect to an intersection 206.

Referring again to FIGS. 1-8, the adaptive notification management system 10 is utilized to assist the driver in operating the vehicle 100 by assigning a priority 42 to the notification 12. While the adaptive notification management system 10 may be utilized in communication with an intersection system 200, as exemplified herein, the adaptive notification management system 10 may be utilized with other applications in which a notification 12 may be assigned a priority 42. For example, if the vehicle 100 has a green light optimal speed advisory (i.e., one example of the vehicle-to-signal application 22a) as a medium priority 42 but has a forward collision warning (i.e., another example of the vehicle-to-signal application 22a) with a forward vehicle as a high priority 42, then the adaptive notification management system 10 is configured to sort the vehicle applications 22. In response, the adaptive notification management system 10 would provide the forward collision warning, via notification 12, to the driver. Thus, the adaptive notification management system 10 is configured to manage the notifications 12 across the vehicle applications 22 to optimize the amount of information provided to the driver.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
receiving, at an adaptive notification management architecture, intersection data based on a location of a vehicle equipped with the adaptive notification management architecture;
receiving, at the adaptive notification management architecture, vehicle data of the vehicle, the vehicle data including at least one of the location of the vehicle and vehicle speed;
arbitrating, via the adaptive notification management architecture, the intersection data and the vehicle data;
generating a confidence score and a severity score based on the arbitrated intersection data and the arbitrated vehicle data; and
generating, based on the confidence score and the arbitrated intersection data and the arbitrated vehicle data, one or more notifications with respect to an intersection.

2. The method of claim 1, wherein the intersection data includes signal, phase, and time (SPaT) data and map data.

3. The method of claim 2, wherein the map data includes a geometry of the intersection.

4. The method of claim 2, wherein the intersection data includes traffic data and pedestrian data.

5. The method of claim 1, wherein receiving the intersection data includes receiving the intersection data from a signal at the intersection.

6. The method of claim 1, wherein receiving the intersection data includes receiving the intersection data from a secondary vehicle proximate to the intersection.

7. The method of claim 1, further including sorting, via the adaptive notification management architecture, vehicle applications based on the severity score and the confidence score.

8. The method of claim 7, further including generating, based on the severity score, a weight for each vehicle application.

9. The method of claim 8, wherein generating the weight for each vehicle application includes executing a deep learning algorithm and assigning, via the deep learning algorithm, a priority for one of the vehicle applications.

10. The method of claim 1, wherein generating the confidence score and the severity score includes calculating a distance to intersection (DTI) and a time to intersection (TTI) of the vehicle.

11. An adaptive notification management system for a vehicle, the adaptive notification management system comprising:
data processing hardware; and
memory hardware in communication with the data processing hardware, the memory hardware storing instructions that when executed on the data processing hardware cause the data processing hardware to perform operations comprising:
receiving, at an adaptive notification management architecture, intersection data based on a location of a vehicle equipped with the adaptive notification management architecture, the intersection data including one or more of signal, phase, and time (SPaT) data, map data, traffic data, and pedestrian data;
receiving, at the adaptive notification management architecture, vehicle data of the vehicle, the vehicle data including at least one of the location of the vehicle and vehicle speed;
arbitrating, via the adaptive notification management architecture, the intersection data and the vehicle data;
generating a confidence score and a severity score based on the arbitrated intersection data and the arbitrated vehicle data;
sorting, via the adaptive notification management architecture, vehicle applications based on the severity score and the confidence score; and
generating, based on the confidence score and the arbitrated intersection data and the arbitrated vehicle data, one or more notifications with respect to an intersection.

12. The adaptive notification management system of claim 11, wherein the map data includes a geometry of the intersection.

13. The adaptive notification management system of claim 11, wherein receiving the intersection data includes receiving the intersection data from a signal at the intersection.

14. The adaptive notification management system of claim 11, wherein receiving the intersection data includes receiving the intersection data from a secondary vehicle proximate to the intersection.

15. The adaptive notification management system of claim 14, further including generating, based on the severity score, a weight for each vehicle application.

16. The adaptive notification management system of claim 15, wherein generating the weight for each vehicle application includes executing a deep learning algorithm and assigning, via the deep learning algorithm, a priority for one of the vehicle applications.

17. The adaptive notification management system of claim 11, wherein generating the confidence score and the severity score includes calculating a distance to intersection (DTI) and a time to intersection (TTI) of the vehicle.

18. An adaptive notification management system for a vehicle, the adaptive notification management system comprising:
data processing hardware; and
memory hardware in communication with the data processing hardware, the memory hardware storing instructions that when executed on the data processing hardware cause the data processing hardware to perform operations comprising:
receiving, at an adaptive notification management architecture, intersection data from at least one of a signal at an intersection and a secondary vehicle proximate to the intersection based on a location of a vehicle equipped with the adaptive notification management architecture, the intersection data including one or more of signal, phase, and time (SPaT) data, map data, traffic data, and pedestrian data;
receiving, at the adaptive notification management architecture, vehicle data of the vehicle, the vehicle data including at least one of the location of the vehicle and vehicle speed;
arbitrating, via the adaptive notification management architecture, the intersection data and the vehicle data;
generating a confidence score and a severity score based on the arbitrated intersection data and the arbitrated vehicle data;
sorting, via the adaptive notification management architecture, vehicle applications based on the severity score and the confidence score;
generating, based on the severity score, a weight for each vehicle application; and
generating, based on the confidence score and the arbitrated intersection data and the arbitrated vehicle data, one or more notifications with respect to an intersection.

19. The adaptive notification management system of claim 18, wherein generating the weight for each vehicle application includes executing a deep learning algorithm and assigning, via the deep learning algorithm, a priority for one of the vehicle applications.

20. The adaptive notification management system of claim 18, wherein generating the confidence score and the severity score includes calculating a distance to intersection (DTI) and a time to intersection (TTI) of the vehicle.
